(19) United States
(12) Patent Application Publication
(10) Pub. No.: US 2004/0260813 A1
(43) Pub. Date: Dec. 23, 2004

(54) Wireless network design generation and optimization

(76) Inventors: Jeff A. Heisserman, Bellevue, WA (US); Christopher Esposito, Issaquah, WA (US); Karel Zikan, Seattle, WA (US); Raju S. Mattikalli, Issaquah, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/261,234

(22) Filed: Sep. 30, 2002

(51) Int. Cl. G06F 15/173

(52) U.S. Cl. 709/226

(57) ABSTRACT

An embodiment of the present invention includes a method to generate a network design. Candidate hubs for a wireless network are generated from a database of available hubs using a first set of criteria. A service level availability (SLA) is associated to each of the candidate hubs using a second set of criteria. A set of network configurations is generated from the candidate hubs. Each of the network configurations maximizes customer coverage and satisfies the associated SLA.

### BACKGROUND

1. Field

Embodiments of the invention relate to the field of networks, and more specifically, to wireless networks.

2. Background

Wireless communication, such as free space optical (FSO) and millimeter wave radio frequency (RF) systems, has become popular recently. The deployment and successful use of wireless equipment poses specific challenges due to its dependence on equipment performance, atmospheric conditions and geometric installation conditions (e.g., line-of-sight). Wireless network design is a process of generating the layout of hubs and links within building environment to ensure a desired network availability and flow capacity.

Techniques for wireless network design have a number of drawbacks. Exhaustive enumeration suffers the computational explosion as the number of hubs increase. At the current computational speeds of the fastest computers, such an exhaustive search for an optimal wireless network design would take thousands or even billions of years. Standard optimization techniques may not provide sufficient solutions.

### BRIEF DESCRIPTION OF THE DRAWINGS

The invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a wireless network geometry according to one embodiment of the invention.

FIG. 3 is a diagram illustrating a network design generator shown in FIG. 1 according to one embodiment of the invention.

FIG. 4 is a flowchart illustrating a process to generate network designs according to one embodiment of the invention.

FIG. 5 is a flowchart illustrating a process to optimize network configurations using a random greedy technique according to one embodiment of the invention.

FIG. 6 is a flowchart illustrating a process to optimize network configurations using a recursive growing technique according to one embodiment of the invention.

FIG. 7 is a flowchart illustrating a process to optimize network configurations using a genetic algorithms technique according to one embodiment of the invention.

### DESCRIPTION

An embodiment of the present invention includes a method to generate a network design. Candidate hubs for a wireless network are generated from a database of available hubs using a first set of criteria. A service level availability (SLA) is associated to each of the candidate hubs using a second set of criteria. A set of network configurations is generated from the candidate hubs. Each of the network configurations maximizes customer coverage and satisfies the associated SLA.

In the following description, numerous specific details are set forth. However, it is understood that embodiments of the invention may be practiced without these specific details. In other instances, well-known circuits, structures, and techniques have not been shown in order not to obscure the understanding of this description.

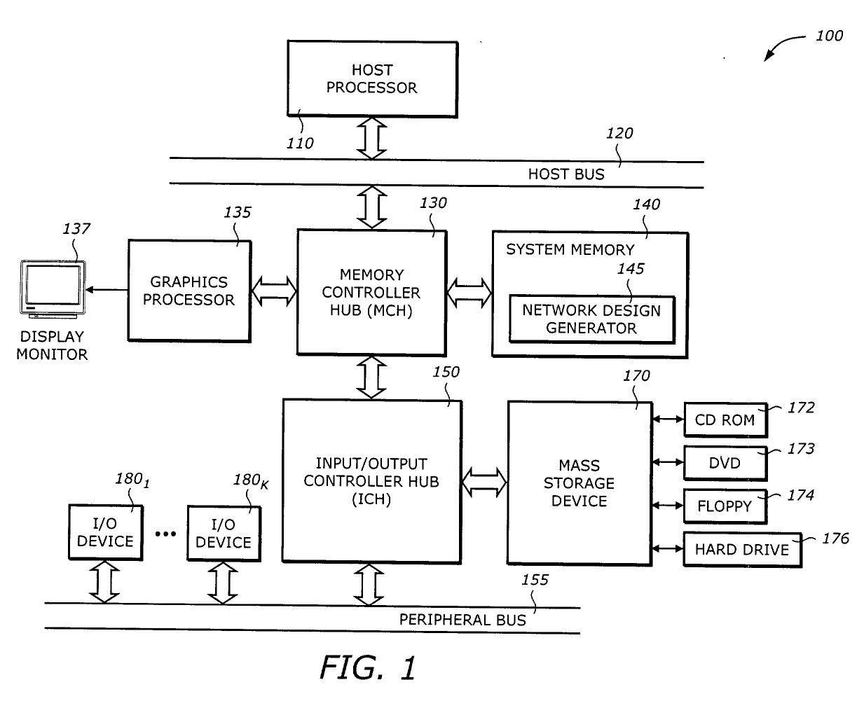

FIG. 1 is a diagram illustrating a system 100 in which one embodiment of the invention can be practiced. The system 100 includes a host processor 110, a host bus 120, a memory control hub (MCH) 130, a graphics processor 135, a display monitor 137, a system memory 140, an input/output control hub (ICH) 150, a peripheral bus 155, a mass storage device 170, and input/output devices 180ₗ to 180_{K}. Note that the system 100 may include more or less elements than these elements.

The host processor 110 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The host bus 120 provides interface signals to allow the processor 110 to communicate with other processors or devices, e.g., the MCH 130. The host bus 120 may support a uni-processor or multiprocessor configuration. The host bus 120 may be parallel, sequential, pipelined, asynchronous, synchronous, or any combination thereof.

The MCH 130 provides control and configuration of memory and input/output devices such as the system memory 140 and the ICH 150. The MCH 130 may be integrated into a chipset that integrates multiple functionalities such as the isolated execution mode, host-to-peripheral bus interface, memory control. The MCH 130 interfaces to the peripheral bus 155. For clarity, not all the peripheral buses are shown. It is contemplated that the system 100 may also include peripheral buses such as Peripheral Component Interconnect (PCI), accelerated graphics port (AGP), Industry Standard Architecture (ISA) bus, and Universal Serial Bus (USB), etc.

The graphics processor 135 is any processor that provides graphics functionalities. The graphics processor 135 may also be integrated into the MCH 130 to form a Graphics and Memory Controller Hub (GMCH). The graphics processor 135 may be a graphics card such as the Graphics Performance Accelerator (AGP) card, interfaced to the MCH 130 via a graphics port such as the Accelerated Graphics Port (AGP) controller. The graphics processor 135 provides interface to the display monitor 137 such as standard progressive scan monitor, television (TV)-out device, and Transition Minimized Differential Signaling (TMDS) controller. The display monitor 137 may be any display device such as Cathode Ray Tube (CRT) monitor, TV set, Liquid Crystal Display (LCD), Flat Panel, and Digital CRT.

The system memory 140 stores system code and data. The system memory 140 is typically implemented with dynamic random access memory (DRAM) or static random access memory (SRAM). The system memory may include program code or code segments implementing one embodiment of the invention. The system memory 140 includes a network design generator 145. The network design generator 145 generates a set of network configurations that are optimal for a number of objectives or criteria. The network design generator 145 may be used by network designer, planner, marketing personnel, customer, or anybody who is interested in planning a network configuration. Any one of the elements of the network design generator 145 may be implemented by hardware, software, firmware, microcode, or any combination thereof. The system memory 140 may also include other programs or data which are not shown, such as an operating system.

The ICH 150 has a number of functionalities that are designed to support I/O functions. The ICH 150 may also be integrated into a chipset together or separate from the MCH 130 to perform I/O functions. The ICH 150 may include a number of interface and I/O functions such as PCI bus interface to interface to the peripheral bus 155, processor interface, interrupt controller, direct memory access (DMA) controller, power management logic, timer, system management bus (SMBus), universal serial bus (USB) interface, mass storage interface, low pin count (LPC) interface, etc.

The mass storage device 170 stores archive information such as code, programs, files, data, applications, and operating systems. The mass storage device 170 may include compact disk (CD) ROM 172, a digital video/versatile disc (DVD) 173, floppy drive 174, and hard drive 176, and any other magnetic or optic storage devices. The mass storage device 170 provides a mechanism to read machine-accessible media. The machine-accessible media may contain computer readable program code to perform tasks as described in the following.

The I/O devices 180ₗ to 180_{K} may include any I/O devices to perform I/O functions. Examples of I/O devices 180ₗ to 180_{K} include controller for input devices (e.g., keyboard, mouse, trackball, pointing device), media card (e.g., audio, video, graphics), network card, and any other peripheral controllers.

Elements of one embodiment of the invention may be implemented by hardware, firmware, software or any combination thereof. The term hardware generally refers to an element having a physical structure such as electronic, electromagnetic, optical, electro-optical, mechanical, electromechanical parts, etc. The term software generally refers to a logical structure, a method, a procedure, a program, a routine, a process, an algorithm, a formula, a function, an expression, etc. The term firmware generally refers to a a logical structure, a method, a procedure, a program, a routine, a process, an algorithm, a formula, a function, an expression, etc that is implemented or embodied in a hardware structure (e.g, flash memory, ROM, EROM). Examples of firmware may include microcode, writable control store, microprogrammed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The machine accessible medium may also include program code embedded therein. The program code may include machine readable code to perform the operations described in the following. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

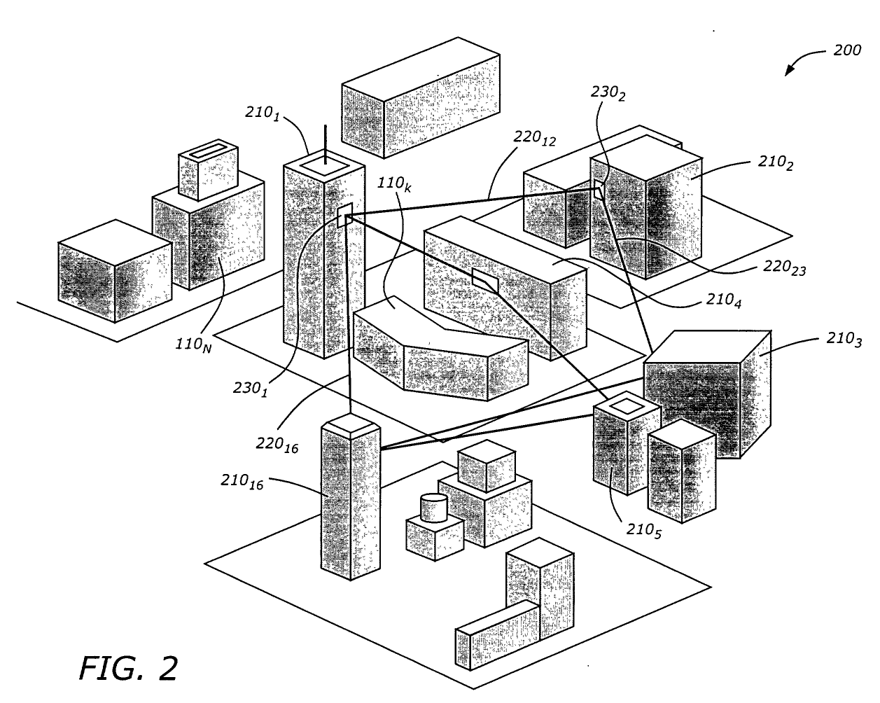

FIG. 2 is a diagram illustrating a wireless network geometry 200 according to one embodiment of the invention. The techniques in the present invention are applicable to any wireless, line-of-sight networks such as FSO and millimeter wave RF.

The wireless network geometry 200 includes a number of buildings 210ⱼ (j=1, . . . , N) and a number of wireless links 220ⱼₖ (j=1, . . . , N, k=1, . . . , N, j ≠k). The network geometry 220 represents a typical metropolitan area where wireless links can be economically and efficiently established for fast data transmission.

Each of the buildings 210ⱼ's may be any commercial, business, government, private, or even residential buildings that needs a service of the wireless network. For illustrative purposes, each building 210ⱼ is shown to have a corresponding equipment installation 230ⱼ. A building may have several such equipment installations, either indoor or outdoor. The equipment installation 230ⱼ includes wireless transceiver such as an optical transceiver that can support fast Ethernet (100 Mbps), Gigabit Ethernet (1250 Mbps), 10 Gigabit ethernet (10 Gbps), OC-3/STM-1 (at 155 Mbps), OC-12 (625 Mbps) and OC-48 (2.488 Gbps). The equipment installation 230ⱼ may transmit and receive wireless or optical beams carrying data.

The wireless link 220ⱼₖ connects the equipment installations 230ⱼ and 230ₖ. The overall link topology forms a network configuration that is optimized for customer coverage under a number of system constraints and criteria.

Each of the equipment installations 220ⱼ's may be referred to as a hub in a network configuration. A hub is in essence the center of network concentrated in a particular building. The location of a hub in a building is selected such that it provides the best services at sufficiently economical cost. Several communication ports located on various floors of a building 210ⱼ may be connected to the hub of the building at the equipment installation 230ⱼ.

A network design generation is a process to provide a feasible set of network configurations that may be optimal for a number of objectives or criteria. Since there are several constraints and criteria to be met, there is no single best network configuration. Rather, the solutions include a number of network configurations that may be optimal in some objectives. These objectives are weighed to provide design priorities. For example, suppose the network planner or designer wants to find the best network configurations that provide the most number of customers, he or she may weigh the network customer count objective or criteria most heavily. One or more network configurations may then be generated from the set of network configurations that meet this priority.

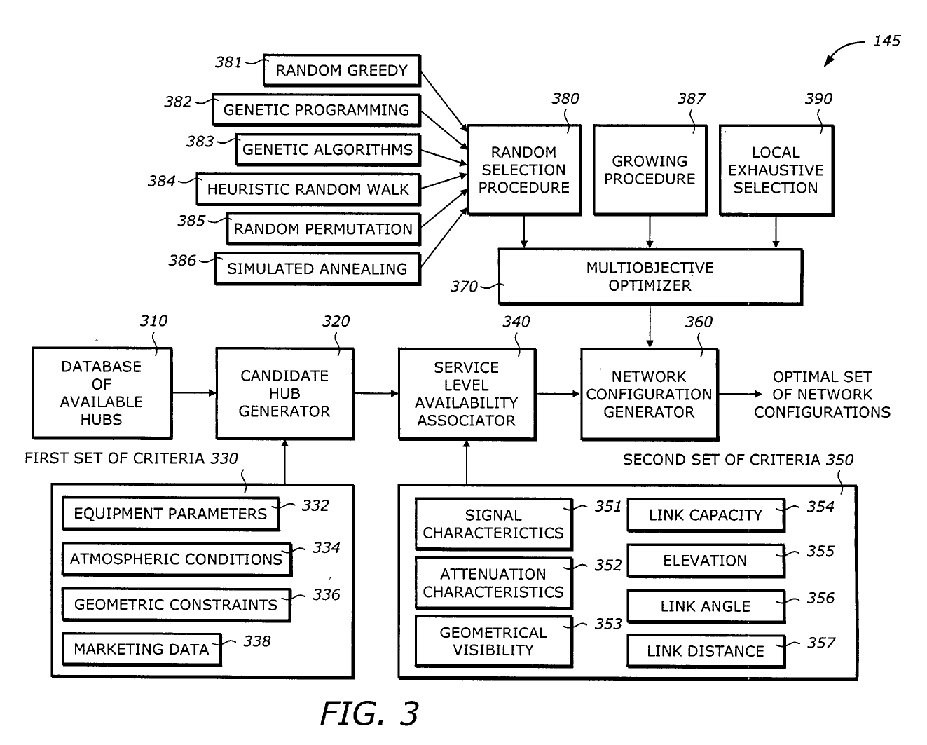

FIG. 3 is a diagram illustrating a network design generator 145 shown in FIG. 1 according to one embodiment of the invention. The network design generator 145 includes a database 310, a candidate hub generator 320, a service level availability (SLA) associator 340, and a network configuration generator 360. The network design generator 145 may also include a graphics program that presents the network configurations in a multi-dimensional system, a user interface module with selection menus, and any other program modules or code.

The database 310 includes information of the available hubs. The available hubs may be determined from a feasibility study of the metropolitan area where the FSO network is to be installed and serviced. Typically, the available hubs include buildings that have high visibility to buildings with high customer concentrations. Examples of available hubs may include commercial buildings that house one, a few, or a large number of companies with high communication needs, a large hotel with business centers, a government building, office spaces in buildings that are available for lease, etc. The database 310 may include information on the three-dimensional (3-D) models of the buildings in the are covered by the network. The 3-D model may include geospatial data, geo-location data (e.g., latitude, longitude), address, elevation, building height, building shape, computer-aided design (CAD) information, etc. The database 310 is typically integrated from multiple databases to provide a rich 3-D model database for the geometrical computations.

The candidate hub generator 320 generating candidate hubs for a free space optical (FSO) network from the database 310 of available hubs using a first set of criteria 330. The first set of criteria 330 includes a number of hub criteria such as equipment parameters 332, atmospheric conditions 334, geometrical constraints 336, and marketing data 338. The equipment parameters 332 may include equipment type (e.g., indoor, outdoor, millimeter wave), installation cost, equipment alignment cost, and service cost. The atmospheric conditions 334 may include lighting condition (e.g., ambient light, sun light), fog, rain, thunderstorm, and snow conditions. The lighting condition may also be classified as geometric because the solar ephemeral or solar interference problems are related to the latitude and the tilt of the earth's rotational axis relative to the earth's axis of rotation about the sun. The geometrical constraints 336 may include line of sight, visibility, installation location (e.g., window, rooftop). The marketing data 338 may include number of customers, customer quality (e.g., customer demand, customer size, customer reputation), market penetration level, etc.

The SLA associator 340 associates a service level availability to each of the candidate hubs using a second set of criteria 350. The second set of criteria 350 includes a number of SLA criteria such as signal characteristics 351, attenuation characteristics 352, geometrical visibility 353, link capacity 354, elevation 355, link angles 356, and link distance 357. The signal characteristics 351 may include signal quality. The attenuation characteristics 352 may include window loss or attenuation (in dB) at a installation site. The geometrical visibility 353 may include the view coverage from the hub and the hub visibility as seen from other hubs. The geometrical, or line-of-sight (LOS), visibility may be determined from the 3-D building information provided by the database 310. The link capacity 354 may include the data transmission rate (in Bps) and the signal bandwidth. The elevation 355 may include altitude, height, and floor number of the hub. The link angles 356 may include the angles of incidence as directed by the hub equipment through the building windows at either end of a link. The link distance 357 may include the distance from the hub to other hubs.

The network configuration generator 360 generates an optimal set of network configurations from the candidate hubs. Each of the network configurations maximizes customer coverage and satisfies the associated SLA. Additionally, each of the network configurations may also minimize a cost value such as a network equipment cost, a network system cost, etc. The customer coverage indicates the ability of the overall network configuration to provide service to the customers within the FSO network. The customer coverage therefore includes both the first and second sets of criteria 330 and 350. These sets of criteria form a multi-objective function to be optimized. The network configuration generator 360 includes a multi-objective optimizer 370. The optimizer 370 optimizes a set of network configurations under system constraints and criteria for a given SLA. The optimizer 370 optimizes the set of network configurations using at least one of a random selection procedure 380, a growing procedure 387, and a local exhaustive selection 390 or a combination of these. The random selection procedure 380 may be at least one of a random greedy procedure 381, a genetic programming procedure 382, a genetic algorithms (GA's) procedure 383, a heuristic random walk 384, a random permutation 385, a simulated annealing procedure 386, and any combination thereof.

The multi-objective optimizer 370 in essence selects a set of optimal network configurations in accordance to some optimality condition. One optimality condition is the Pareto optimality. A network configuration is a member of the Pareto set if there is no other network configuration that is better in every objective. Using a Pareto set, a network designer or planner can choose which objectives to weight most heavily and then find the Pareto network configuration that matches the priorities. Each member of the Pareto set corresponds to a particular combination of weighting factors between objectives.

The optimizer 370 may determine a score vector to determine the worthiness or merit of a network configuration or a path of the network. The scoring vector may be determined from a number of factors, including a cost value for each of the network configurations. The cost value may be a hub customer count, a network customer count, a visibility value, a customer category value, a network equipment cost, a network system cost, or any combination thereof.

The optimizer 370 may use an optimization procedure, or a combination of these procedures. For example, the optimizer 370 may use a random greedy selection procedure combined with a local exhaustive selection to generate potentially optimal set of network configurations. The optimizer 370 may also randomly select an optimization procedure in a genetic programming context.

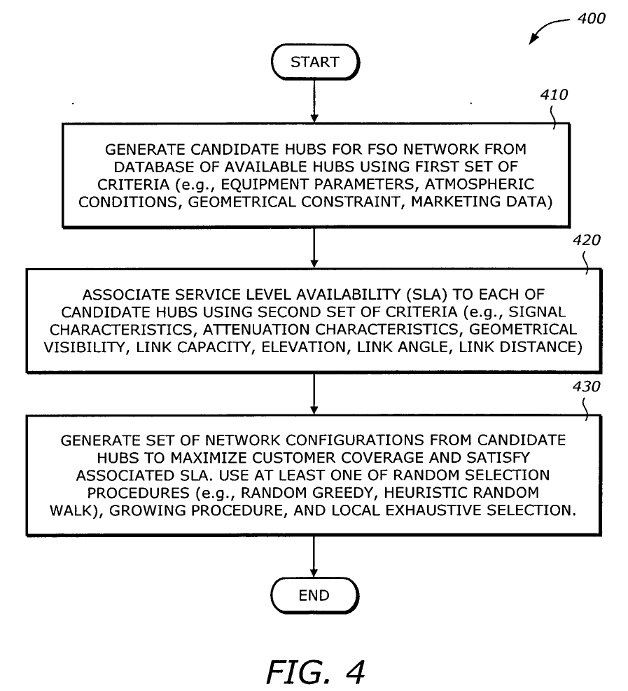

FIG. 4 is a flowchart illustrating a process 400 to generate network designs according to one embodiment of the invention.

Upon START, the process 400 generates candidate hubs for the wireless network from a database of available hubs using a first set of criteria (Block 410). The first set of criteria may include equipment parameters, atmospheric conditions, geometrical constraints, and marketing data. Next, the process 400 associates a service level availability (SLA) to each of the candidate hubs using a second set of criteria (Block 420). The second set of criteria may include signal characteristics, attenuation characteristics, geometrical visibility, link capacity, elevation, link angles, and link distance.

Then, the process 400 generates a set of network configurations from the candidate hubs to maximize customer coverage and satisfy the associated SLA (Block 430). The generation of the set of network configurations may use at least one of a random selection procedure, a growing procedure, and a local exhaustive selection, or a combination of these. The random selection procedure may be at least one of random greedy procedure, a genetic programming procedure, a genetic algorithms (GA's) procedure, a heuristic random walk, a random permutation, a simulated annealing procedure, and any combination thereof.

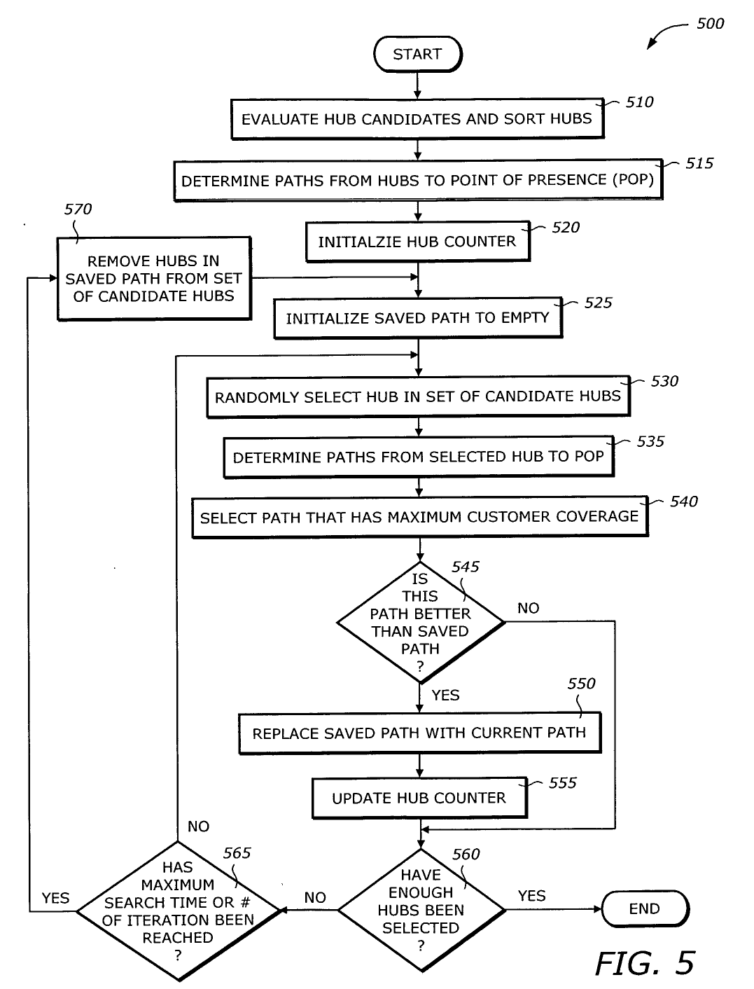

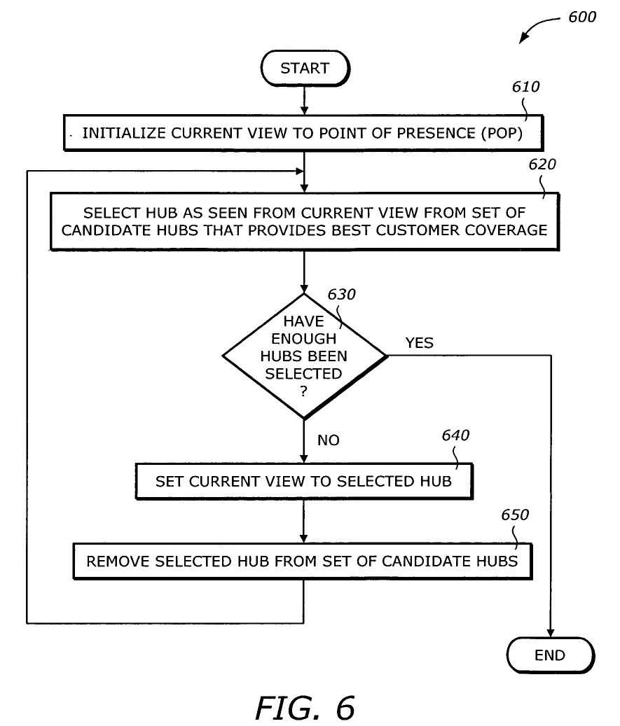

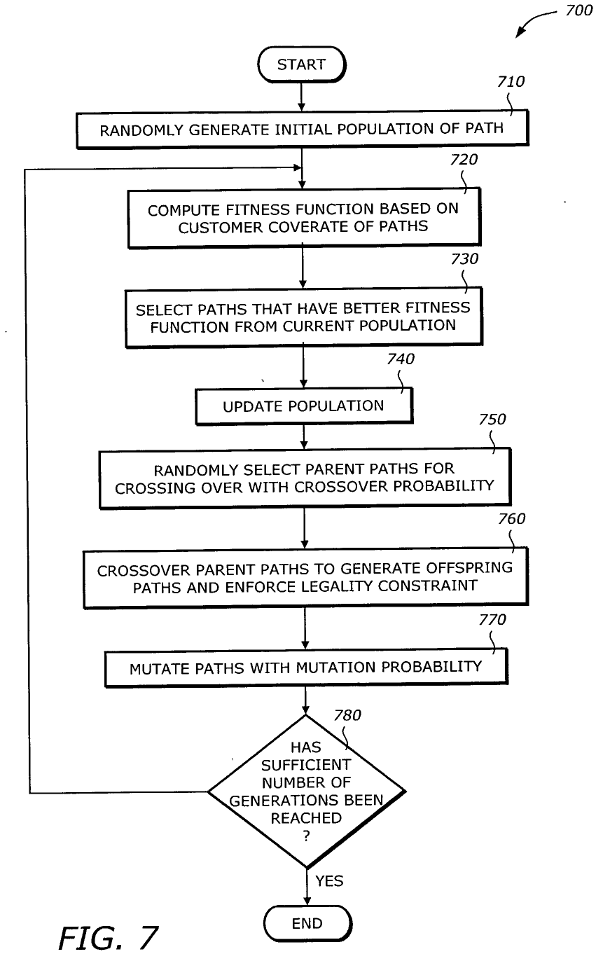

The Block 430 in FIG. 4 represents the optimization of the set of network configurations. As discussed above, the optimization may be performed using any of the above procedures or any combination of these procedures. In one embodiment, a random greedy selection procedure is used. A random greedy procedure selects randomly a hub from a set of hubs with maximum additional customer coverage in a path to the point of presence (POP). The POP is a point where the wireless network is connected to the Internet or a metropolitan, national, or international telecommunications network. The path that has the best customer coverage is kept and the selection progresses until a sufficient number of hubs have been reached. Any variation of the basic random greedy procedure may be employed. One such example is the procedure described in FIG. 5. A growing procedure starts from one or more hubs and grow to include a next hub such that the customer coverage is locally optimal. The starting hub may be one with superior customer coverage. When multiple hubs are started together, the growing process may take place in parallel where each starting hub grows its own path. Any variation of such a growing procedure may be employed. An example of a recursive growing procedure is illustrated in FIG. 6. A random optimization using GA's usually starts with a random population of solution strings or chromosomes. The solution strings are encoded with the hub identifiers. The process is iterated through selection, cross-over, mutation, etc. Any variation of such GA's procedure may be employed. An example of a GA procedure is illustrated in FIG. 7. In any of these procedures, different hubs may be connected to the POP via different paths, i.e., the hubs do not have to be on a single path. The topology of the routes from the hubs to the POP may be a tree, a ring, or more general graph.

FIG. 5 is a flowchart illustrating a process 500 to optimize network configurations using a random greedy technique according to one embodiment of the invention.

Upon START, the process 500 evaluates hub candidates and sort hubs according to the hub merit scores (Block 510). Next, the process 500 determines paths from hubs to a point of presence (POP) (Block 515). Then, the process 500 initializes a hub counter that keeps track of the number of selected hubs (Block 520).

Next, the process 500 initializes a saved path to an empty path (Block 525). Then, the process 500 randomly selects a hub in the set of candidate hubs (Block 530). Next, the process 500 determines all the paths from the selected hub to the POP (Block 535). Then, the process 500 selects the path that has the maximum customer coverage (Block 540).

Next, the process 500 determines if the selected path has better customer coverage than the saved path (Block 545). If not, the process 500 proceeds to Block 560. Otherwise, the process 500 replaces the saved path with the current path (Block 550). Then; the process 500 updates the hub counter (Block 555).

Next, the process 500 determines if enough hubs have been selected (Block 560). If so, the process 500 is terminated. Otherwise, the process 500 determines if the maximum search time or the maximum number of iterations or cycles has been reached (Block 565). If not, the process 500 returns to Block 530. Otherwise, the process 500 removes the hubs in the saved path from the set of candidate hubs (Block 570) and then returns to Block 525. The process 500 then continues until enough hubs have been selected.

FIG. 6 is a flowchart illustrating a process 600 to optimize network configurations using a recursive growing technique according to one embodiment of the invention.

Upon START, the process 600 initializes the current view to the point of presence (POP) (Block 610). Then, the process 600 selects a hub as seen from the current view from the set of candidate hubs that provides the best customer coverage (Block 620). Next, the process 600 determines if enough hubs have been selected (Block 630). If so, the process 600 is terminated. Otherwise, the process 600 sets the current view to the selected hub (Block 640). Then, the process 600 removes the selected hub from the set of candidate hubs so that it will not be considered again in the next iteration (Block 650). Next, the process 600 returns to block 620 to continue until enough hubs have been selected.

FIG. 7 is a flowchart illustrating a process 700 to optimize network configurations using a genetic algorithms technique according to one embodiment of the invention.

Upon START, the process 700 randomly generates an initial population of paths formed by hubs selected from the candidate hubs (Block 710). Each path includes connectivity of several hubs through the point of presence (POP). Each path is considered as a chromosome or a solution string in the GA's context. The path length may be variable and random or may be fixed. Next, the process 700 computes the fitness function of each path based on the customer coverage (Block 720). Then, the process 700 selects the paths that have better fitness functions from the current population (Block 730). The selection may be based on the roulette wheel selection process, or proportional to the fitness function. Next, the process 700 updates the population (Block 740). For example, paths that have low fitness functions are discarded. Typically, the population of paths is kept approximately constant from one generation to the next.

Then, the process 700 randomly selects parent paths for crossing over with a cross-over probability (Block 750). Next, the process 700 perform cross-over operation on the parent paths to generate offspring paths (Block 760). During crossing over, the process 700 enforces the legality constraints to avoid generation of illegal paths. Illegal paths are those that are not feasible, such as complete link blockage or hub invisibility. Duplication of hubs is also checked. Then, the process 700 performs a mutation operation on the population with a mutation probability (Block 770). A mutation may involve a random change to a hub in a path to another hub not appearing in the path.

Next, the process 700 determines if a sufficient number of generations has been reached (Block 780). In addition, the process 700 may also determine if sufficient number of hubs has been selected in the population. If not, the process 700 returns back to Block 720 to continue for the next generation. Otherwise, the process 700 is terminated.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
generating candidate hubs for a wireless network from a database of available hubs using a first set of criteria;
associating a service level availability (SLA) to each of the candidate hubs using a second set of criteria; and
generating a set of network configurations from the candidate hubs, each of the network configurations maximizing customer coverage and satisfying the associated SLA.

2. The method of claim 1 wherein the first set of criteria includes at least one of a plurality of equipment parameters, a plurality of atmospheric conditions, a plurality of geometrical constraints, and a plurality of marketing data.

3. The method of claim 2 wherein the second set of criteria includes at least one of signal characteristics of equipment, attenuation characteristics due to the atmospheric conditions, geometrical visibility, elevation, link capacity, link angles, and link distances.

4. The method of claim 1 wherein generating the set of network configurations comprises:
optimizing the set of network configurations under an optimality condition.

5. The method of claim 4 wherein optimizing comprises:
optimizing the set of network configurations under an Pareto optimality condition.

6. The method of claim 4 wherein optimizing comprises:
optimizing the set of network configurations using at least one of a random selection procedure, a growing procedure, and a local exhaustive selection.

7. The method of claim 6 wherein the random selection procedure is at least one of a random greedy procedure, a genetic programming procedure, a genetic algorithm procedure, a heuristic random walk, a random permutation, and a simulated annealing procedure.

8. The method of claim 6 wherein optimizing comprises:
evaluating scoring vectors of the network configurations; and comparing the scoring vectors.

9. The method of claim 8 wherein evaluating the scoring vectors comprises:
evaluating a cost value for each of the network configurations, the cost value being at least one of a hub customer count, a network customer count, a visibility value, a network equipment cost, a network system cost, and a customer category value.

10. The method of claim 4 wherein optimizing the set of network configurations comprises:
optimizing the set of network configurations to minimize network system cost.

11. An article of manufacture comprising:
a machine-accessible medium including data that, when accessed by a machine, causes the machine to perform operations comprising:
generating candidate hubs for a wireless network from a database of available hubs using a first set of criteria;
associating a service level availability (SLA) to each of the candidate hubs using a second set of criteria; and
generating a set of network configurations from the candidate hubs, each of the network configurations maximizing customer coverage and satisfying the associated SLA.

12. The article of manufacture of claim 11 wherein the first set of criteria includes at least one of a plurality of equipment parameters, a plurality of atmospheric conditions, a plurality of geometrical constraints, and a plurality of marketing data.

13. The article of manufacture of claim 12 wherein the second set of criteria includes at least one of signal characteristics of equipment, attenuation characteristics due to the atmospheric conditions, geometrical visibility, elevation, link capacity, link angles, and link distances.

14. The article of manufacture of claim 11 wherein the data causing the machine to perform generating the set of network configurations comprises data that causes the machine to perform operations comprising:
optimizing the set of network configurations under an optimality condition.

15. The article of manufacture of claim 14 wherein the data causing the machine to perform optimizing comprises data that causes the machine to perform operations comprising:
optimizing the set of network configurations under an Pareto optimality condition.

16. The article of manufacture of claim 14 wherein the data causing the machine to perform optimizing comprises data that causes the machine to perform operations comprising:
optimizing the set of network configurations using at least one of a random selection procedure, a growing procedure, and a local exhaustive selection.

17. The article of manufacture of claim 16 wherein the random selection procedure is at least one of a random greedy procedure, a genetic programming procedure, a genetic algorithm procedure, a heuristic random walk, a random permutation, and a simulated annealing procedure.

18. The article of manufacture of claim 16 wherein the data causing the machine to perform optimizing comprises data that causes the machine to perform operations comprising:
evaluating scoring vectors of the network configurations; and
comparing the scoring vectors.

19. The article of manufacture of claim 18 wherein the data causing the machine to perform evaluating the scoring vectors comprises data that causes the machine to perform operations comprising:
evaluating a cost value for each of the network configurations, the cost value being at least one of a hub customer count, a network customer count, a visibility value, a network equipment cost, a network system cost, and a customer category value.

20. The article of manufacture of claim 14 wherein the data causing the machine to perform optimizing the set of network configurations comprises data that causes the machine to perform operations comprising:
optimizing the set of network configurations to minimize network system cost.

21. A system comprising:
a processor; and
a memory coupled to the processor, the memory including program code that, when executed by the processor, causes the processor to:
generate candidate hubs for a wireless network from a database of available hubs using a first set of criteria,
associate a service level availability (SLA) to each of the candidate hubs using a second set of criteria, and
generate a set of network configurations from the candidate hubs, each of the network configurations maximizing customer coverage and satisfying the associated SLA.

22. The system of claim 21 wherein the first set of criteria includes at least one of a plurality of equipment parameters, a plurality of atmospheric conditions, a plurality of geometrical constraints, and a plurality of marketing data.

23. The system of claim 22 wherein the second set of criteria includes at least one of signal characteristics of equipment, attenuation characteristics due to the atmospheric conditions, geometrical visibility, elevation, link capacity, link angles, and link distances.

24. The system of claim 21 wherein the program code causing the processor to generate the set of network configurations comprises program code that causes the processor to:
optimize the set of network configurations under an optimality condition.

25. The system of claim 24 wherein the program code causing the processor to optimize comprises program code that causes the processor to:
optimize the set of network configurations under an Pareto optimality condition.

26. The system of claim 24 wherein the program code causing the processor to optimize comprises program code that causes the processor to:
optimize the set of network configurations using at least one of a random selection procedure, a growing procedure, and a local exhaustive selection.

27. The system of claim 26 wherein the random selection procedure is at least one of a random greedy procedure, a genetic programming procedure, a genetic algorithm procedure, a heuristic random walk, a random permutation, and a simulated annealing procedure.

28. The system of claim 26 wherein the program code causing the processor to optimize comprises program code that causes the processor to:
evaluate scoring vectors of the network configurations; and
compare the scoring vectors.

29. The system of claim 28 wherein the program code causing the processor to evaluate the scoring vectors comprises program code that causes the processor to:
evaluate a cost value for each of the network configurations, the cost value being at least one of a hub customer count, a network customer count, a visibility value, a network equipment cost, a network system cost, and a customer category value.

30. The system of claim 24 wherein the program code causing the processor to optimize the set of network configurations comprises program code that causes the processor to:
optimize the set of network configurations to minimize network system cost.
